(19) United States
(12) Patent Application Publication
(10) Pub. No.: US 2010/0158045 A1
(43) Pub. Date: Jun. 24, 2010

(54) METHOD FOR TRANSMITTING/RECEIVING DATA FRAME IN CAN PROTOCOL

(75) Inventors: Chang Min Shin, Daejeon (KR); Tae Man Han, Daejeon (KR); Ho Sang Ham, Daejeon (KR); Won Jun Lee, Seoul (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/543,876

(22) Filed: Aug. 19, 2009

(30) Foreign Application Priority Data
Dec. 23, 2008 (KR) 10-2008-0132627

(51) Int. Cl. H04J 3/24

(52) U.S. Cl. 370/473

(57) ABSTRACT

Provided is a method for transmitting/receiving data in a CAN protocol. First, it is determined whether the size of CAN message data to be transmitted exceeds the size of the data field. If the size of the CAN message data exceeds the size of the data field, the CAN message data are fragmented to generate data fragments smaller in size than the data field, A CAN data frame including a control field and a data field is generated with respect to each of the data fragments, and the generated CAN data frame is transmitted.

### CROSS-REFERENCE TO RELATED APPLICATIONS

This application claims priority under 35 U.S.C. §119 to Korean Patent Application No. 10-2008-0132627, filed on Dec. 23, 2008, in the Korean Intellectual Property Office, the disclosure of which is incorporated herein by reference in its entirety.

### TECHNICAL FIELD

The following disclosure relates to a method for transmitting/receiving data in a Controller Area Network (CAN) protocol, and in particular, to a method for transmitting/receiving a data frame in a CAN protocol, which transmits data in a fragmented manner and reconstitutes the received data fragments to restore the original data.

### BACKGROUND

A CAN (Controller Area Network) was developed by BOSCH for application in the automotive industry. CAN is now widely applied in various industries in addition to the automotive industry. A CAN protocol is a multi-master, message-based serial network communication protocol that provides a maximum signaling rate of 1 Mbps defined in the ISO-11898 standard.

CAN supports communications between different Electronic Control Units (ECUs) in an automobile, which are connected through twisted-pair cables supporting half-duplex protocol and a Carrier Sense Multiple Access/Collision Detection with Arbitration on Message Priority (CSMA/CD+AMP) protocol. CAN secures high reliability such as high noise immunity, error detection, and error collection.

Prior to data transmission, a CAN node detects whether a CAN bus is in use, and performs an inter-message collision check. Instead of including the addresses of transmit/receive (TX/RX) nodes, a message frame has an identifier that allows each node to identify a message in a CAN network.

CAN is classified into two modes—CAN Version 2.0A and CAN Version 2.0B, according to the identifiers in messages. CAN Version 2.0A has an identifier 11 bits long, while CAN Version 2.0B has an identifier 29 bits long.

Upon receiving a message from a TX node, an RX node determines whether it is required for the RX node, on the basis of the corresponding identifier. If the received message is determined to be unnecessary, the RX node does not accept the message. If a RX node receives several necessary messages simultaneously, it selects the higher-priority messages on the basis of the identifier values. Here, processing of the lower-priority messages is delayed until the higher-priority messages are completely processed. Thereafter, a retransmission is performed upon completion of the processing of the higher-priority messages. That is, identifiers are used to identify messages and determine their priorities.

The ECUs of each electronic device are connected through a CAN communication network to deliver various control messages.

CAN data communication is message-based. Each ECU in an electronic device may transmit several messages. Herein, each message comprises a unique message ID with prioritization/identification functions and up to 8-byte data, and the message has a 46-bit ID field (for CAN 2.0A) and control bits for communication.

When a desired message ID is present on a communication bus, the corresponding message is receivable. The lower the ID number, the higher its priority. Herein, data may be generated on a byte basis from 1 byte to 8 bytes, TX/RX data in a message may be randomly generated within the range of an allowed data size, and TX/RX nodes may communicate data in accordance with a predefined data format.

However, because the data field of a CAN data frame has a maximum size of 8 bytes, a CAN TX node may not transmit data with a size of more than 8 bytes.

### SUMMARY

In one general aspect, a method for transmitting a CAN data frame, which includes a control field and a data field, by a CAN TX node includes: determining whether the size of CAN message data to be transmitted exceeds the size of the data field; fragmenting the CAN message data to generate data fragments smaller in size than the data field, if the size of the CAN message data exceeds the size of the data field; generating a CAN data frame, including a control field and a data field, with respect to each of the data fragments; and transmitting the generated CAN data frame.

In another general aspect, a method for receiving a CAN data frame, which includes a control field and a data field, by a CAN RX node includes: performing a first determination operation of determining whether data present in the data field are data fragments of CAN message data, on the basis of the control field; generating a CAN data structure by extracting the data fragments from the CAN data frame, if the data are the data fragments of the CAN message data; performing a second determination operation of determining whether the data fragment is the last data fragment; and reconstituting the CAN message data by extracting the data fragments from the CAN data structure, if the data fragment is the last data fragment.

Other features and aspects will be apparent from the following detailed description, the drawings, and the claims.

### BRIEF DESCRIPTION OF THE DRAWINGS

FIG. 1 is a diagram illustrating a data frame transmitted by a CAN TX node according to an exemplary embodiment.

FIG. 2 is a diagram illustrating the structure of a CAN 2.0A data frame used in a CAN data frame transmitting method according to an exemplary embodiment.

FIG. 3 is a diagram illustrating the structure of a CAN 2.0B data frame used in a CAN data frame transmitting method according to an exemplary embodiment.

FIG. 4 is a flow chart illustrating a data fragmentation process of a TX node in a CAN data frame transmitting method according to an exemplary embodiment.

FIG. 5 is a flow chart illustrating a data reconstitution process of a RX node in a CAN data frame receiving method according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

It will be understood that when an element is referred to as being ‘connected to’ or ‘coupled to’ another element, it may be directly connected or coupled to the other element or intervening elements may be present. As used herein, the term ‘and/or’ includes any and all combinations of one or more of the associated listed items. The terminology used herein is for the purpose of describing particular embodiments only and is not intended to be limiting of exemplary embodiments. As used herein, the singular forms ‘a’, ‘an’ and ‘the’ are intended to include the plural forms as well, unless the context clearly indicates otherwise. It will be further understood that the terms ‘comprises’, ‘comprising’, ‘includes’ and/or ‘including’ when used in this specification, specify the presence of stated features, integers, steps, operations, elements, and/or components, but do not preclude the presence or addition of one or more other features, integers, steps, operations, elements, components, and/or groups thereof.

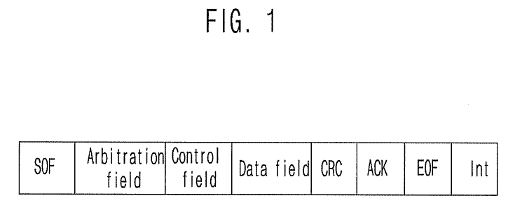

FIG. 1 is a diagram illustrating a data frame transmitted by a CAN TX node according to an exemplary embodiment.

Referring to FIG. 1, a Start-Of-Frame (SOF) field indicates the start of a message frame. The SOF field is located at the very front of the message frame and has a default value of ‘0’.

An arbitration field has an 11-bit identifier and a Remote Transmission Request (RTR) bit having a default value of ‘0’. When the RTR bit value is ‘0’, a CAN message is a data frame. When the RTR bit value is ‘1’, the CAN message means Remote Transmission Request (RTR). That is, the RTR bit value of ‘1’ means that the CAN message is not a data frame but a remote frame.

The remote frame is used to request transmission of data from a node to another node on a data bus. The remote frame does not include a data field because it is a message frame used before transmission of data.

A control field is constituted by 6 bits. Each of bits r0 and r1 is a region reserved for later use and has a value of ‘0’. A 4-bit Data Length Code (DLC) indicates the number of bytes of a data field.

If CAN message data are fragmented and data fragments (i.e., fragmented data) are present in a data field, the control field sets a fragmentation flag to indicate this. For example, if the size of the CAN message data exceeds 8 bytes, a data fragmentation operation is performed and data fragments are included in the data field. In this case, the fragmentation flag of the control field may be set to ‘recessive’.

If the CAN message data does not exceed 8 bytes, the data included in the data field are not data fragments. In this case, the fragmentation flag of the control field may be set to ‘dominant’.

The data field includes data that are to be transmitted from a node to another node. The data field may include 0 to 8-byte data. If the data size exceeds a certain size (e.g., 8 bytes), they are fragmented because they cannot be transmitted simultaneously. When the CAN message data are fragmented to generate data fragments, a message ID and a sequence parameter are combined with the data fragments to be transmitted. Herein, the message ID indicates that the data fragments are a portion of the CAN message data, and the sequence parameter contains fragmentation sequence information.

An operation of combining a message ID and a sequence parameter with each data fragment to be transmitted is repeated. If the last data fragment is present, a data delimitation parameter (a Seq. Delimiter) indicating this may be set to ‘recessive’. If the data fragment is not the last data fragment, the data delimitation parameter may be set to ‘dominant’.

That is, the fragmentation flag included in the control field is used to indicate the presence of a data fragment in the data field, and the data delimitation parameter included in the data field is used to indicate whether the data fragment is the last data fragment.

A Cyclic Redundancy Check (CRC) field has a 15-bit CRC code, and it is followed by a bit with a value of ‘1’ indicating the end of the data field.

An ACKnowledge (ACK) field is constituted by 2 bits, and the first bit is a slot bit with a value of ‘0’. However, it may be recorded as a value of ‘1’ if the message is transmitted from another node and successfully received. The second bit has a value of ‘1’.

An End-Of-Frame (EOF) field is constituted by 7 bits each of which has a value of ‘1’. The EOF field is followed by an intermission (Int) field that is a frame intermission field of 3 bits each of which has a value of ‘1’. After the period of the 3-bit Int field, a CAN bus line is recognized as an idle status.

Thereafter, it is followed by a bus idle time having a certain length including ‘0’.

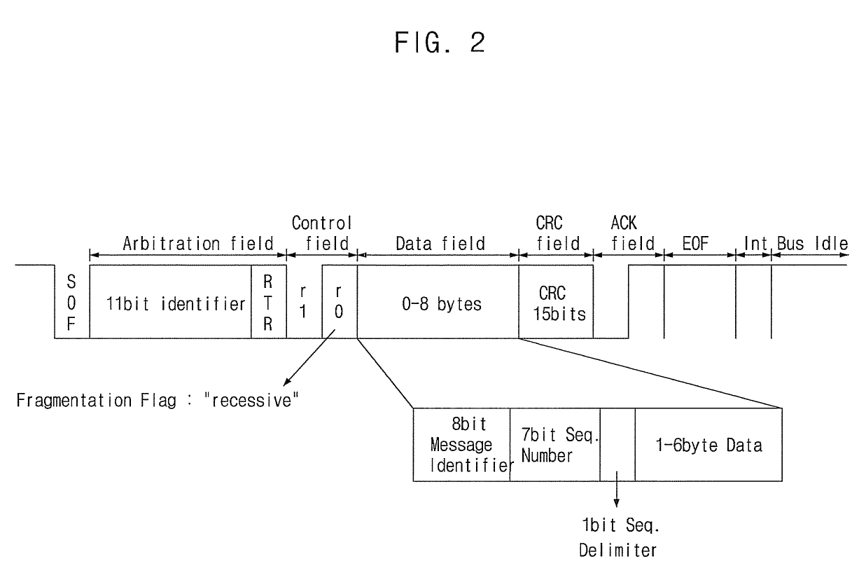

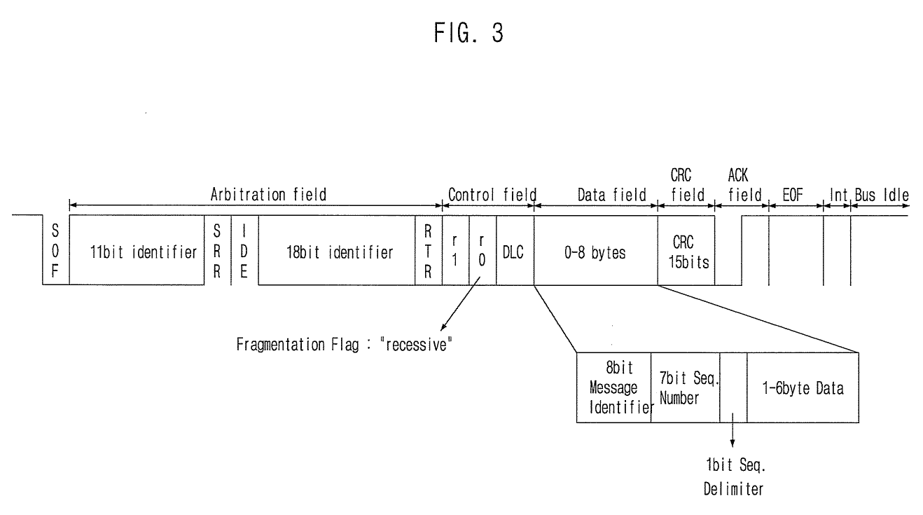

FIG. 2 is a diagram illustrating the structure of a CAN 2.0A data frame used in a CAN data frame transmitting method according to an exemplary embodiment. FIG. 3 is a diagram illustrating the structure of a CAN 2.0B data frame used in a CAN data frame transmitting method according to an exemplary embodiment.

The CAN of FIG. 3 is identical in structure and operation to the standard CAN (i.e., CAN 2.0A) with the exception that it is an extended CAN having a 29-bit identifier in an arbitration field. Exemplary embodiments are applicable to any one of the standard CAN 2.0A and the extended CAN 2.0B.

The structure of the CAN data frame of FIGS. 2 and 3 is substantially identical to the structure of the CAN data frame of FIG. 1. Thus, a description of an overlap with FIG. 1 will be omitted, and a detailed description will be given of control bits and data bits that are important for data fragmentation and data reconstitution in the exemplary embodiments.

Referring to FIG. 2, bit r0 or r1 of the control field is used as a fragmentation flag to indicate whether data are fragmented in the CAN data frame structure.

For example, if the size of CAN message data to be transmitted by a TX node exceeds 8 bytes, the data are fragmented and the bit r0 or r1 indicates a recessive bit. If the TX data size does not exceed 8 bytes, the fragmentation flag indicates a dominant bit.

A data field includes a Message Identifier, a Seq. Number, a Seq. Delimiter, and 1 to 6-byte data.

One CAN message data and another CAN message data may be discriminated through a Message Identifier. For example, if both a message A and a message B are all 24 bytes long, each of the messages A and B may be fragmented to a 6-byte size to generate 4 data fragments.

When the message A is fragmented into data fragments A1, A2, A3 and A4 and the message B is fragmented into data fragments B1, B2, B3 and B4, the data fragments A1 and B1 cannot be discriminated from each other without message identifier in the data field. The message identifier may have a unique message ID that is given to each message to discriminate it from all other messages.

Thus, the data fragments A1 to A4 have the same message ID value and also the data fragments B1 to B4 have the same message ID value. However, the message ID value of the data fragments A1 to A4 is different from the message ID value of the data fragments B1 to B4.

According to the configuration of the exemplary embodiment, when there are several data fragments received by a RX node, the unique message ID of the message identifier is important for extracting data fragments from the same CAN message data and reconstituting the data fragments in accordance with the fragmentation sequence.

The Seq. Number is a place to store a sequence parameter (Seq). For example, if CAN message data exceeding 8 bytes are fragmented to a certain size (e.g., 6 bytes) prior to transmission from a TX node, the sequence number is necessary for a RX node to reconstitute the received data fragments in accordance with the data fragmentation sequence to restore the original TX data of the TX node. Thus, if the data fragmentation sequence is not predefined, it is difficult for the RX node to restore the original TX data by data reconstitution.

According to the exemplary embodiments, data are fragmented to a certain size sequentially from the front of a message. The sequence parameter value is counted up by a factor of ‘1’ whenever a data fragment is transmitted by the TX node. This operation is repeated until the sequence parameter value is smaller by ‘1’ than the maximum number of data fragments.

The sequence parameter value is initialized when data fragments constitute a new CAN data frame. According to an exemplary embodiment, the sequence parameter value is initialized to ‘0’.

The Seq. Delimiter is a data delimitation parameter. If it is the last data fragmentation operation, the data delimitation parameter is set to ‘recessive’; if not, the data delimitation parameter is set to ‘dominant’.

For example, if 36-byte CAN message data are fragmented to 6-byte size, the data delimitation parameter is set to ‘dominant’ in the first fragmentation operation. In this case, it is determined that there remain data to be fragmented, and the data continue to be fragmented. The dominant status is maintained until the fifth fragmentation operation. The data delimitation parameter is set to ‘recessive’ in the sixth (i.e., last) fragmentation operation, and it is determined that there are no more data to be fragmented.

The function of the data delimitation parameter in the RX node is described below.

When receiving data frames including data fragments, the RX node determines whether the data delimitation parameter is dominant or recessive. If the data delimitation parameter is dominant, the RX node determines that there are more data to be received. If the data delimitation parameter is recessive, the RX node determines that the data fragment included in the received data frame is the last data fragment. In this case, the RX node does not receive any more data frames, and extracts and reconstitutes the received data fragments.

A region accommodating data is present at the end of the data field to carry the data fragments.

As described above, the data field in the standard CAN 2.0A data frame has a maximum size of 8 bytes. Although it has been described that the data fragmentation size is 6 bytes, the exemplary embodiments are not limited thereto. For example, if message data exceeding 8 bytes are fragmented to 5-byte size prior to transmission, the sum of the sizes of the remaining three regions of a data field, i.e., a message identifier, a Seq. Number, and a Seq. Delimiter becomes 3 bytes. Thus, the total size of the data, the message identifier, the Seq. Number, and the Seq. Delimiter is adjustable within the range of 8 bytes.

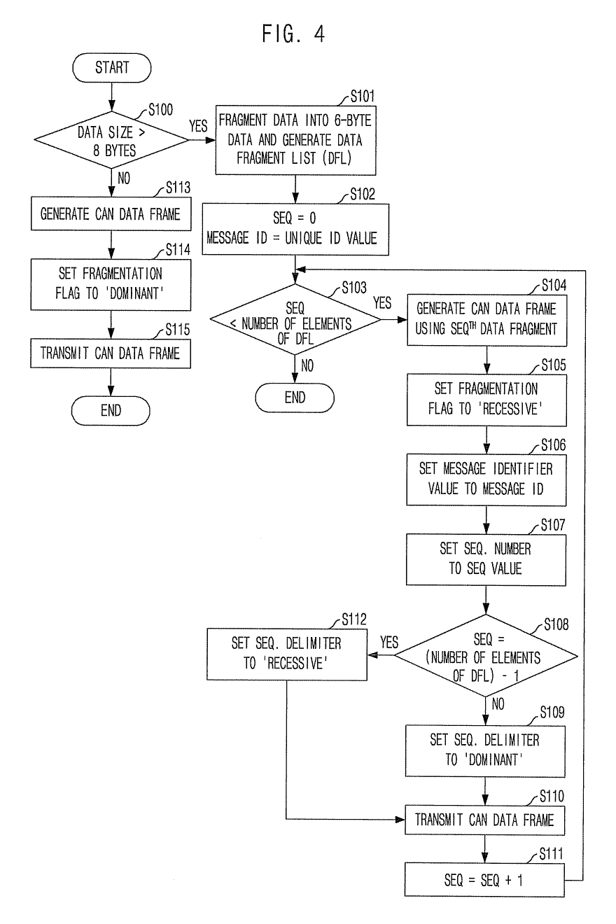

FIG. 4 is a flow chart illustrating a data fragmentation process of a TX node in a CAN data frame transmitting method according to an exemplary embodiment.

‘Recessive’ and ‘dominant’ bits are used to indicate the data status in a CAN data frame, i.e., whether the data are fragmented data. A bit r0 or r1 may be used as a fragmentation flag. If the size of data to be transmitted by the TX node (hereinafter referred to as TX data) is larger than 8 bytes, the bit r0 or r1 is set to a recessive bit, which is logical 1; if not, it is set to a dominant bit, which is logical 0.

Referring to FIG. 4, the TX node measures the size of TX data in step S100. If the TX data size does not exceed 8 bytes, the TX node generates and transmits a CAN data frame in accordance with the existing CAN protocol in steps S113 to S115. In this case, bit r0 or r1 of a control field acts as a fragmentation flag, which is set to dominant in step S114.

If the TX data size exceeds 8 bytes, the TX node fragments the TX data.

First, the TX node fragments the TX data to a certain size (e.g., 6 bytes) and generates a Data Fragment List (DFL) in step S101. Then, the TX node sets a sequence parameter Seq to ‘0’ and sets a message ID to a unique value different from those of other messages in step S102.

Herein, the TX data are fragmented to a certain size (e.g., 6 bytes) sequentially from the front of the message, and the DFL is generated in accordance with the fragmentation sequence. In setting the sequence parameter, the data fragmentation sequence starts not from ‘1’ but from ‘0’ according to an exemplary embodiment, but it is not limited thereto. Also, the sequence parameter is equal to the data fragment generation sequence.

If the TX data size is 8 bytes, the TX data may be transmitted without the data fragmentation operation. Herein, the sequence parameter has a value of ‘0’, and the DFL has only one element.

If the sequence parameter value is smaller than the number of the elements of the DFL (e.g., if the number of the elements of the DFL is ‘2’ and the sequence parameter value is ‘0’) in step S103, the TX node generates a CAN data frame by using the Seq^{th} data fragment of the DFL in step S104.

Then, the TX node sets the fragmentation flag value of the control field in the CAN data frame to ‘recessive’ in step S105, sets the message identifier value to the message ID in step S106, and sets the Seq. Number value to the sequence parameter value in step S107.

If the sequence parameter value is smaller by ‘1’ than the number of the elements of the DFL in step S108, it means that the corresponding data fragment is the last data fragment. In this case, the TX node sets a data delimitation parameter to ‘recessive’ in step S112. If the corresponding data fragment is not the last data fragment, the TX node sets the data delimitation parameter to ‘dominant’ in step S109.

Thereafter, the TX node transmits the CAN data frame in step S110, and increases the sequence parameter value by a factor of ‘1’ in step S111. These operations are repeated until the sequence parameter value is equal to the number of the elements of the DFL. If the sequence parameter value is equal to the number of the elements of the DFL in step S103, the data fragmentation process is ended.

It will be readily understood that the processes of fragmenting/transmitting the CAN message data according to the exemplary embodiments are not limited to the CAN protocol.

In general, message data can be fragmented into a plurality of data fragments with a certain size; and a message ID indicating that the data fragments are the fragments of the message data, and a sequence parameter indicating the fragmentation sequence are set for each data fragment. Thereafter, a series of data frames including the respective data fragments and the corresponding message IDs and the sequence parameter may be generated and transmitted. The data frame may further include a fragmentation flag indicating that the data fragment is the data fragment of the original message data.

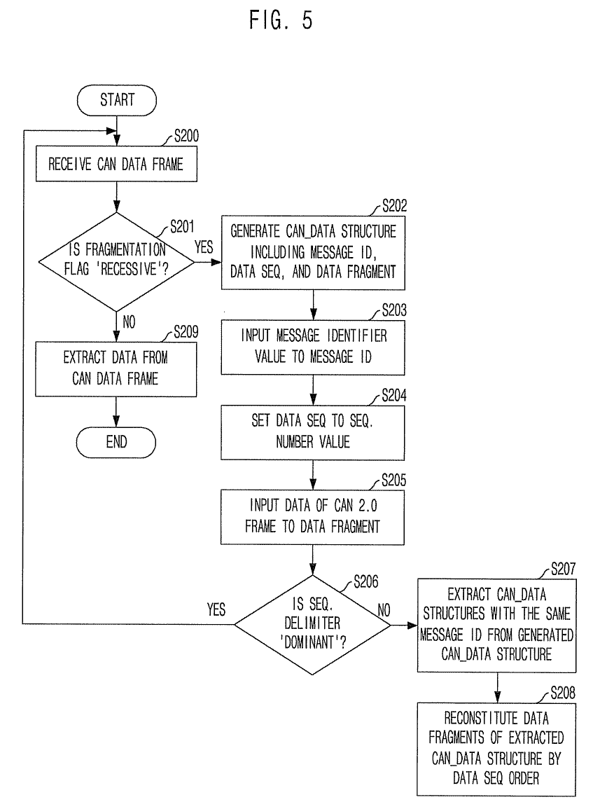

FIG. 5 is a flow chart illustrating a data reconstitution process of a RX node in a CAN data frame receiving method according to an exemplary embodiment.

Referring to FIG. 5, the RX node receives a CAN data frame in step S200, and checks a fragmentation flag value in step S201. If the fragmentation flag value is not ‘recessive’ in step S201, the RX node extracts data from a data field in step S209 and ends the data reconstitution process.

If the fragmentation flag value is ‘recessive’ in step S201, it means that the data of the received CAN data frame are fragmented data. In this case, the following operations are performed.

First, the RX node generates a CAN data structure including Message ID, Data Seq, and Data Fragment fields in step S202. That is, the CAN data structure includes a region for receiving the data fragments, a region for receiving a message ID value for identifying CAN message data including the data fragments, and a region for receiving a sequence parameter value containing the fragmentation sequence information.

To this end, the RX node inputs a message identifier value to the Message ID in step S203, a sequence parameter value to the Data Seq in step S204, and the data of the CAN data frame to the Data Fragment in step S205.

Thereafter, if a data delimitation parameter is ‘dominant’ (S206), the RX node waits to receive another CAN data frame in step S200 to repeat the above operations.

It can be determined if the data fragment in the received CAN data frame is the last data fragment in step S206 through a data delimitation parameter that is set to ‘recessive’ in the last data fragmentation operation.

If the data delimitation parameter is ‘recessive’, it is determined that the data fragment in the received CAN data frame is the last data fragment. If the data delimitation parameter is ‘recessive’, the RX node extracts CAN data structures with the same message ID value from the generated CAN data structures in step S207, and reconsititutes the data fragments of the extracted CAN data structures in accordance with the sequence according to the sequence parameter value in step S208.

Thereafter, the RX node restores the original TX data from the TX node, and ends the data reconstitution process.

The CAN data frame transmitting/receiving method according to the exemplary embodiments can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet). The computer-readable storage medium can also be distributed over network coupled computer systems so that the computer readable codes are stored and executed in a distributed fashion. Also, functional programs, codes, and code segments for accomplishing the present invention can be easily construed by programmers skilled in the art to which the present invention pertains.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for transmitting a Controller Area Network (CAN) data frame, which includes a control field and a data field, by a CAN transmit (TX) node, the method comprising:
determining whether a size of CAN message data to be transmitted exceeds the size of the data field;
fragmenting the CAN message data to generate data fragments smaller in size than the data field, if the size of the CAN message data exceeds the size of the data field;
generating a CAN data frame, including a control field and a data field, for each of the data fragments; and
transmitting the generated CAN data frame.

2. The method of claim 1, wherein the fragmenting of the CAN message data comprises:
sequentially fragmenting the CAN message data to a certain size; and
generating a Data Fragment List including as many sequential elements as the number of the data fragments.

3. The method of claim 1, wherein the generating of a CAN data frame comprises generating a data field including:
the data fragment;
a message ID indicating that the data fragment is a portion of the CAN message data; and
a sequence parameter containing the fragmentation sequence information of the data fragment.

4. The method of claim 3, wherein the generating of a data field comprises:
setting a data delimitation parameter indicating whether the data fragment is the last data fragment.

5. The method of claim 4, wherein the data delimitation parameter is determined using the sequence parameter and the number of the data fragments.

6. The method of claim 4, wherein the generating of a data field further comprises:
determining that the data fragment is the last data fragment, by using the number of the data fragments and the sequence parameter containing the fragmentation sequence information of the data fragment.

7. The method of claim 1, wherein the generating of a CAN data frame comprises:
generating the control field by using a fragmentation flag indicating whether the data fragment is present in the data field.

8. The method of claim 1, wherein the generating of a CAN data frame comprises:
generating the data field by using the data fragment of the sequence corresponding to a sequence parameter containing the fragmentation sequence information of the data fragment in a Data Fragment List (DFL) including the data fragments that are sequentially fragmented to a certain size; and
generating the control field by using a fragmentation flag indicating whether the data fragment is present in the data field.

9. The method of claim 1, further comprising:
generating the data field including the CAN message data, if the size of the CAN message data does not exceed the size of the data field;
generating the control field by setting a fragmentation flag indicating whether the data fragment is present in the data field; and
transmitting the CAN data frame including the data field and the control field.

10. The method of claim 1, further comprising:
increasing a sequence parameter containing the fragmentation sequence information, whenever transmitting the generated CAN data frame; and
repeating the generating and transmitting of the CAN data frame until the number of the data fragments is larger than the increased sequence parameter.

11. A method for receiving a Controller Area Network (CAN) data frame, which includes a control field and a data field, by a CAN receive (RX) node, the method comprising:
performing a first determination operation of determining whether data present in the data field are data fragments of CAN message data, on the basis of the control field;
generating a CAN data structure by extracting the data fragments from the CAN data frame, if the data are the data fragments of the CAN message data;
performing a second determination operation of determining whether the data fragment is the last data fragment; and
reconstituting the CAN message data by extracting the data fragments from the CAN data structure, if the data fragment is the last data fragment.

12. The method of claim 11, wherein the first determination operation uses a fragmentation flag that is present in the control field to indicate whether the data present in the data field are the data fragments.

13. The method of claim 11, wherein the CAN data structure comprises:
a message ID indicating that the data are the data fragments of the CAN message data and discriminating the CAN data structure from other CAN message data;
a sequence parameter containing fragmentation sequence information of the data fragment; and
the extracted data fragments.

14. The method of claim 11, wherein the second determination operation uses a data delimitation parameter that is present in the data field to indicate whether the data fragment is the last data fragment.

15. The method of claim 14, further comprising, if it is determined that the data fragment is not the last data fragment by the second determination operation:
performing the first determination operation, the generating of a CAN data structure, and the second determination operation for a new RX CAN data frame.

16. The method of claim 11, wherein the reconstituting of the CAN message data comprises:
extracting a CAN data structure indicating that the data fragment is a portion of the CAN message data and having the same message ID that discriminates the CAN message data from other CAN message data; and
reconstituting the data fragments included in the extracted CAN data structure, by using a sequence parameter containing fragmentation sequence information.

17. A method for transmitting a data frame, comprising:
fragmenting message data into a plurality of data fragments;
setting a message ID, indicating that the data fragments are the fragments of the message data, and a sequence parameter, indicating the sequence of each of the data fragments, with respect to each of the data fragments;
generating a data frame, including each of the data fragments, the corresponding message ID, and the sequence parameter, with respect to each of the data fragments; and
transmitting the generated data frame.

18. The method of claim 17, wherein the data frame includes a fragmentation flag indicating that the data fragments are the fragments of the message data.
